(19) United States
(12) Patent Application Publication
(10) Pub. No.: US 2005/0269370 A1
(43) Pub. Date: Dec. 8, 2005

(54) Fluid-dispensing circuit with check valves

(75) Inventors: Umberto Marazzi, Medolla (IT); Giorgio Manfredini, Cavezzo (IT); Monica Clo', San Cesario sul Panaro (IT); Leopoldo Mazzalveri, Urbino (IT)

Correspondence Address: SUGHRUE MION, PLLC, 2100 PENNSYLVANIA AVENUE, N.W., SUITE 800, WASHINGTON, DC, 20037, US

(73) Assignee: CPS COLOR EQUIPMENT S.P.A., SAN FELICE SUL PANARO (MO) (IT)

(21) Appl. No.: 10/522,893

(22) PCT Filed: Jul. 23, 2003
(86) PCT No.: PCT/IB03/03386

§ 371 Date: Feb. 1, 2005

(30) Foreign Application Priority Data
Aug. 1, 2002 (IT) BO2002A000508

(51) Int. Cl. B67D 5/40

(52) U.S. Cl. 222/383.1

(57) ABSTRACT

A circuit for dispensing fluids, in particular, dyes, inks, paints and the like, including pump means including a variable-volume chamber with at least one flexible wall. The pump means communicate with an output duct for dispensing the fluids. Two one-way valves are mounted in series in the outlet duct.

The present invention relates to the field of circuits and machines for metering and dispensing fluids and in particular, dyes, inks, paints and similar products.

The invention was devised particularly in relation to a dispensing circuit comprising pump means which include a variable-volume chamber with at least one flexible wall and in which the pump means communicate with an output duct for dispensing the fluids.

The invention also comprises a machine which uses one or more of the above-mentioned circuits in its interior.

In the field of machines for metering and dispensing colouring fluids, the use of bellows pumps in cooperation with on/off valves which regulate the suction of the fluid from a reservoir and its output from a delivery nozzle is rated highly. The particular combinations which are achieved can in fact ensure very precise performance, particularly when small quantities of product are metered. However, known machines are subject to prolonged stoppage periods for cleaning of the parts of the system. In fact deposits often form, particularly on the abutment surfaces of the valves, because of the impurities that are present in the fluid treated. The deposits result directly in failure of the valves to seal, giving rise to leakages of product, whilst the flow of product passing through the system undergoes unexpected pressure reductions. The accuracy of the system is thus reduced, particularly when it depends on a control system that is based on stored theoretical data or on calibration values, or even on feedback which presupposes correct operation of the valves.

The same disadvantages are present in the device disclosed in U.S. Pat. No. 4,886,189 and which comprises a container for the liquid which container includes a housing and a flexible diaphragm in the interior of the housing for holding the liquid. An actuator is coupled to the diaphragm for moving the diaphragm between an extended position in which the diaphragm can hold more of the liquid and retracted positions in which the diaphragm holds less of the liquid than when in the extended position. A force transmitting unit is coupled to the actuator for causing the actuator to move the diaphragm in a direction from the extended position towards a completely retracted position to dispense the liquid from the container. A single one-way valve is disposed in the suction tube to allow the liquid to be drawn out of the container, but preventing any return of the liquid into the same container.

The object of the present invention is to solve the problems of the prior art and, in particular, to provide a dispensing circuit which requires only a few quick maintenance operations.

Another object of the present invention is to provide a dispensing circuit that has a low risk of malfunctioning due to soiling and blockage of the valves.

A further object of the present invention is to provide a dispensing circuit and a dispensing machine which are inexpensive, highly accurate and reliable, and easy to use.

In order to achieve the objects indicated above, the subject of the invention is a dispensing circuit of the type indicated in the introduction to this description, characterized in that the circuit comprises two one-way valves mounted in series in the output duct.

According to a preferred embodiment of the invention, the first valve which is encountered along the output duct has the function of a stopcock for retaining the fluid during operations to clean or replace the second valve, which is the actual delivery valve. In a particularly advantageous variant, the pump means comprise a main body which delimits the variable-volume chamber at least partially and the output duct is formed partially inside the main body and extends outside it. According to this configuration, at least one of the two one-way valves and, in particular, the delivery valve, is mounted in the output duct, outside the main body, in a position that is easily accessible to the operator. By virtue of this arrangement, the maintenance operation on the delivery valve is performed without the need to dismantle the pump means in order to gain access to the internal members, and without the need to perform any operation to stop the outlet of fluid, which is prevented automatically by the one-way stopcock valve which remains closed owing to the absence of pressure. A solution of this type enables an operator to operate quickly and easily, reducing machine stoppage times.

According to another particularly advantageous variant, the delivery valve comprises a hollow body which has the functions both of an outer casing and of a guide for a closure member that is mounted movably inside it. The closure member comprises a flat abutment surface which ensures a seal by bearing on the ridge of a knife-edged abutment disposed inside the hollow body. Since the contact between the abutment surface and the knife-edge or blade is minimal, the system is self-cleaning. In fact it is difficult for the impurities to get between the blade and the abutment surface and, on the rare occasions when this may happen, the flow of fluid is in any case sufficient to move the impurity to one of the sides of the knife-edge. To ensure even better sealing, a seal made of resilient material such as, for example, an elastomer, may be interposed between the ridge and the flat abutment surface, so that the knife-edge can sink into the seal. These characteristics ensure less frequent maintenance operations, keeping the valves clean for longer and reducing the risks of malfunctioning owing to leakage.

According to another particularly advantageous variant, a further improvement in the performance of the circuit is achieved by the insertion of one or more filters in the circuit, or even by the incorporation thereof in one or more of the valves.

An additional characteristic of the invention provides for the mounting of a one-way valve in an inlet duct communicating with the variable-volume chamber, this valve being partially open in the rest position and preferably having a different working travel from the stopcock valve.

The advantage achieved by this embodiment is that of leaving an escape route for air, facilitating complete filling of the variable-volume chamber. This results directly in a lower risk of cavitation and more precise delivery.

In a particularly advantageous variant, all of the valves of the delivery circuit comprise elements that are functionally identical to those described for the delivery valve.

Further characteristics and advantages will become clear from the detailed description given with reference to the appended drawings which are provided purely by way of non-limiting example and in which:

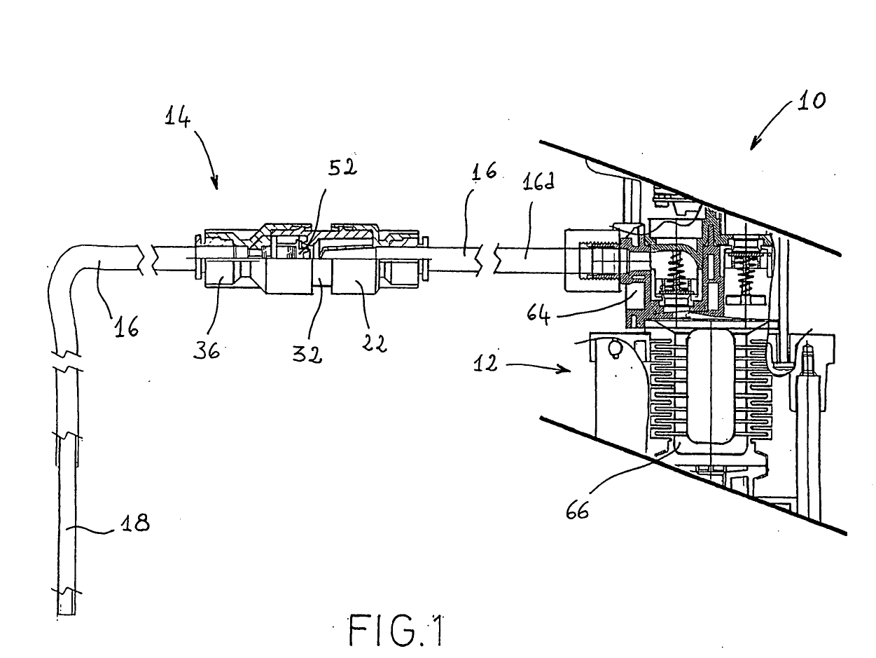

FIG. 1 is a partially-sectioned, front elevational view of a dispensing circuit according to the present invention,

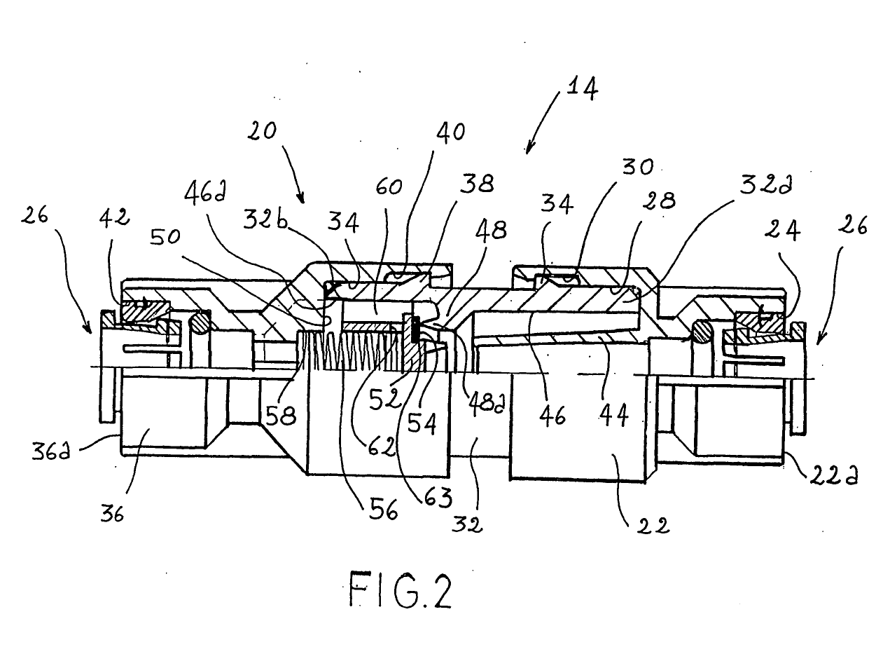

FIG. 2 is a partially-sectioned, longitudinal view of a one-way delivery valve according to the present invention,

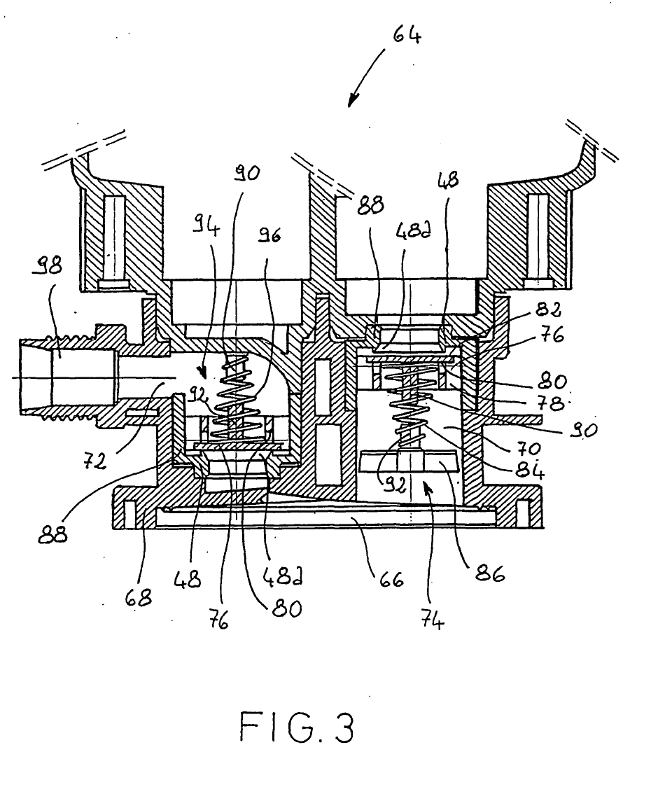

FIG. 3 is a vertical section through the head of a bellows pump inserted in the dispensing circuit of FIG. 1, in which the one-way valves fitted at the inlet and the output of the bellows chamber can be seen, and

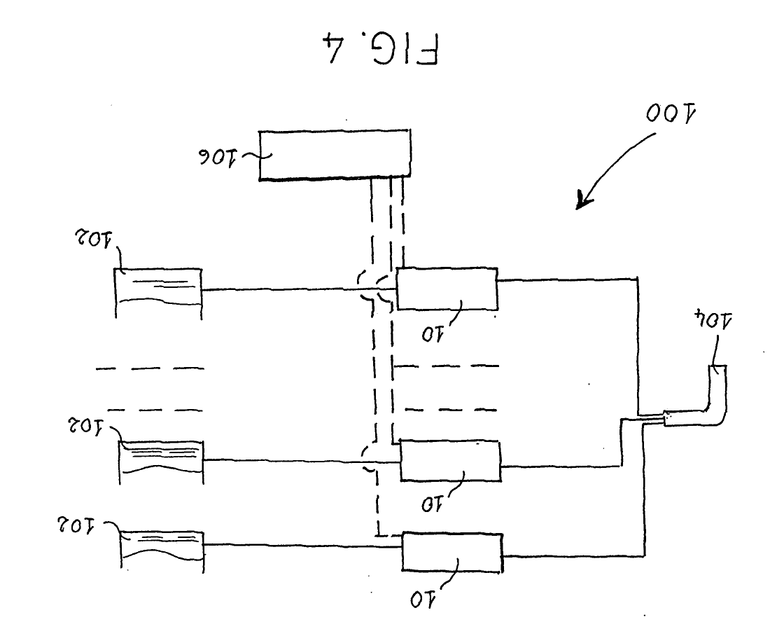

FIG. 4 is a non-limiting example of a layout of a dispensing machine which uses, in its interior, a dispensing circuit of the type shown in FIG. 1.

With reference now to FIG. 1, a dispensing circuit 10 comprises a pump 12 of the type with a variable-volume chamber such as, for example, a bellows or diaphragm pump, and a one-way delivery valve 14 mounted outside the pump 12 in a delivery duct 16 which extends from the pump 12 and terminates in a nozzle 18.

The delivery valve 14 has an outer body 20 (FIG. 2) preferably but in non-limiting manner comprising three hollow components suitable for being fitted into one another. In the embodiment shown in FIG. 2, an inlet component 22 has, at an end 22a thereof, a housing 24 for the insertion of a quick-fit tube attachment 26 of known type. At the opposite end of the inlet component 22 there is a hole 28, which is preferably but not exclusively cylindrical, with an annular recess 30 in its side wall. An end 32a of a guide component 32 which, preferably but in non-limiting manner, is substantially cylindrical can be inserted in the hole 28 and has in its outer wall a tooth 34 which is preferably annular and which can be inserted in the radial recess 30. The other end 32b of the guide component 32 can be housed in a hole 34 having a base wall 50 and formed in an outlet component 36 substantially similar to the inlet component 22; a second tooth 38 which is preferably annular and projects from the outer surface of the guide component 32 is inserted in an annular recess 40 formed in the lateral surface of the hole 34. At its other end 36a, the outlet component 36 has a housing 42 which is substantially similar to the housing 24 of the inlet component 22 and in which is fitted a second quick-fit attachment 26 with a through-cavity which communicates with the hole 39.

Preferably but in non-limiting manner, a filter 44 is formed inside the inlet component 22 and projects into a portion of the cavity 46 which extends through the entire guide component 32 and communicates with the cavities that extend through the inlet component 22 and the outlet component 36, respectively.

An abutment 48 is formed in the cavity 46. By way of example, the abutment 48 may take the form of a collar which projects radially from the wall of the cavity 46 towards its interior and then extends longitudinally relative to the cavity 46 to define an annular knife-edged terminal projection 48a.

A closure member 52 with a flat abutment surface 54 is mounted movably in the portion 46a of the cavity 46 between the abutment 48 and the base wall 50 of the hole 34. The closure member 52 is kept with its flat abutment surface 54 pressed against the ridge of the annular knife-edge 48a by a spring 56 or other resilient element. The spring 56 is preferably but in non-limiting manner guided by a housing 58 formed in the base wall 50 of the outlet component 36. The closure member 52 is guided inside the cavity portion 46a, preferably but in non-limiting manner by circumferentially spaced-apart guide fins 60, and also has one or more holes 62, preferably radial holes, for the outlet of air which may be trapped in cavities resulting, for example, from the shape imparted by production by casting. Moreover, a seal 63 made of soft or resilient material such as, for example, an elastomer, may be mounted on the flat abutment surface 54 to promote sealing between the flat abutment surface 54 and the ridge of the annular knife-edge 48a.

The components of the outer body 20 and the closure member 52 may be produced inexpensively, for example, by injection moulding of plastics material.

FIG. 3 shows an embodiment of a head 64 mounted on a bellows chamber 66 of the pump 12. The head 64 comprises a main body 68 in which an inlet duct 70 and an output duct 72, communicating with the bellows chamber 66, are formed. A valve 74, preferably a one-way valve, is inserted in the inlet duct 70. The valve 74 comprises a closure member 76 which is preferably similar or identical to the closure member 52 of the delivery valve 14 and, in particular, has similar peripheral guide fins 78 and similar air-outlet hole or holes 80 and flat abutment surface 82. A spring 84 or other resilient thrust means keeps the closure member 76 connected to a stationary element 86 in the inlet duct 70. Upstream of the closure member 76 in the inlet duct 70 there is an abutment 48 with an annular knife-edged terminal projection 48a substantially similar to the projection already described with reference to the delivery valve 14. For example, but in non-limiting manner, the abutment 48 may be formed on a bush 88 fitted in the inlet duct 70.

The closure member 76 is mounted downstream of the abutment 48 so as to close the valve 74 by striking the abutment 48 as soon as a predetermined pressure value is reached or exceeded in the bellows chamber 66 whereas, when the valve 74 is in the rest position, the closure member 76 preferably but in non-limiting manner leaves the inlet duct 70 partially or fully open. This can be achieved, for example, with the use of a spring which, at rest, has a length that is shorter than the length required to keep the closure member 76 in contact with the knife-edged terminal projection 48a.

It is also possible to provide a device for limiting the opening travel of the valve 74, for example, comprising a pin 90 on the base of the closure member 76 opposite a second pin 92 on the stationary element 86. The respective lengths of the two pins are selected in accordance with a combination such as to allow them to abut one another at a predetermined travel during the opening of the valve.

A valve 94 similar or identical to the valve 74, in which similar elements or elements with the same function are indicated with the same reference numerals, is inserted in the output duct 72. A spring 96 fitted in the valve 94 is of a length such as to enable the output duct 72 also to be closed in the rest position, and the closure member 76 and the abutment 48 are in positions such as to allow the valve to be opened when the pressure in the bellows chamber 66 reaches or exceeds a predetermined value.

The output duct 72 comprises, downstream of the valve 94, a tube-attachment device 98 to which one end of the portion 16a of the delivery duct 16 is connected, directly or with the interposition of known means, the opposite end being connected to the delivery valve 14.

With reference now to FIG. 4, a dispensing machine 100 comprises one or more dispensing circuits 10, preferably but in non-limiting manner each communicating with its own supply reservoir 102 and with a delivery nozzle 104, although the possibility of one or more circuits having a common reservoir and/or nozzle is not excluded, for example, if they are intended to operate in parallel. A control system 106 is connected to the dispensing circuits 10, in particular in order to control the movements of the bellows pumps by means of suitable actuators.

When the control system 106 brings about the expansion of a bellows chamber 66 in a dispensing circuit 10, the valve 74 is opened and the fluid is drawn from the corresponding reservoir 102. As the bellows chamber 66 is gradually filled, the pressure difference relative to the fluid in the reservoir 102 decreases, causing the valve 74 to return to the rest position. If the valve 74 is formed so as to remain partially open, complete filling of the bellows chamber 66 is promoted, given that the air remaining inside has an escape route, allowing the fluid which still has some inertia to enter. The advantage achieved is that of avoiding the danger of cavitation of the pump and increasing the precision of the dose of fluid delivered.

When the control system 106 brings about contraction of the bellows chamber, the pressure inside the chamber rises and brings about closure of the valve 74 and opening of the valve 94 which, up to this point, has remained closed. When the fluid under pressure reaches the delivery valve 14 it opens the valve, passing through the filter and continuing towards the nozzle 104.

The valve 94 is preferably but in non-limiting manner formed so as to withstand pressures lower that those which cause the delivery valve 14 to open, given that its function is mainly that of a stopcock during maintenance of the delivery valve 14, during which it prevents the discharge of the fluid that is contained in the bellows chamber 66 and is not subject to pressure. This avoids the need to dismantle the head 64 each time the delivery valve 14, which is positioned outside the pump 12 in a readily accessible position, is to be cleaned.

To assist the filter 44 in the valve 14 or as an alternative thereto, one or more filters (not shown) may be provided upstream of this valve; preferably these filter/s are advantageously mounted in the delivery duct 16 in order also to benefit from easier maintenance and/or replacement.

Further advantages of the invention are connected with the construction of some details; for example, the air-outlet holes 62 and 80 in the closure members 52 and 76 further reduce the risk of cavitation. The guide fins 78 and 60 ensure efficient sliding of the closure members inside the respective guide bodies 32 and 88, allowing the stream of fluid to flow as linearly as possible and offering the minimum flow resistance, thus considerably reducing pressure losses as the fluid passes through the valves. As well as considerably reducing costs, the preferred production of all of the valves mentioned in injection-moulded plastics material also permits the use of materials that are particularly resistant to chemical attack, for example, by the fluids to be delivered.

Naturally, the principle of the invention remaining the same, the constructional details and characteristics and the forms of embodiment may vary widely with respect to those described and illustrated, without thereby departing from the scope of the present invention.

1. A dispensing circuit for dyes, inks, paints or similar fluids, comprising pump means (12) including a, variable-volume chamber (66) with at least one flexible wall, the pump means (12) communicating with at least one nozzle (18) through an output duct (72) and a delivery duct (16) for dispensing the fluids, wherein a first one-way valve (94) is disposed in said output duct (72), characterized in that a second one-way valve (14) is mounted in series with said first one-way valve (94) in said delivery duct (16) between said first one-way valve (94) and said at least one nozzle (18).

2. A dispensing circuit according to claim 1, in which the pump means (12) comprise a main body (64) which delimits the variable-volume chamber (66) at least partially, characterized in that said output duct (72) is formed partially inside the main body (64) and said delivery duct (16) extends partially outside said main body (64).

3. A dispensing circuit according to claim 2, characterized in that the at least one of the two one-way valves (14, 94) that is mounted in the outlet duct comprises a hollow body (32), the closure member (52) comprising a flat abutment surface (54), an abutment inside the hollow body comprising the ridge of a knife-edged element (48a) shaped for bearing against the flat abutment (54), and resilient means (56) associated with the closure member (52) for pressing it against the knife-edged element (48a).

4. A dispensing circuit according to claim 1, characterized in that a filter (44) is mounted externally upstream of the at least one of the two one-way valves (14, 94).

5. A dispensing circuit according to claim 3, characterized in that at least one of the two one-way valves (14, 94) that are mounted in the output duct (16, 72) comprises a filter.

6. A dispensing circuit according to claim 3, characterized in that the at least one of the two one-way valves (14, 94) that is mounted in the output duct (16, 72) comprises resilient sealing means (63) interposed between the flat abutment surface (54) and the ridge of the knife-edged element (48a).

7. A dispensing circuit according to claim 1, characterized in that the variable-volume chamber (66) also communicates with an inlet duct (70), a third one-way valve (74) which is partially open in the rest position being mounted in the inlet duct (70).

8. A dispensing circuit according to claim 7, characterized in that said third one-way valve (74) has a travel which is different from the travel of at least one of said first and second two one-way valves (14, 94).

9. A dispensing circuit according to claim 7, characterized in that each of said first and second one-way valves (14, 94) and said third one-way valve (74) comprises a hollow body (70, 72, 88), a closure member (76) mounted movably inside the hollow body (70, 72, 88), the closure member (76) comprising a flat abutment surface (54), an abutment inside the hollow body comprising the ridge of a knife-edged element (48a) shaped far bearing against the flat abutment surface (54), and resilient means mounted between the closure and the hollow body.

10. A dispensing circuit, according to claim 1, characterized in that the pump means (12) comprise a bellows pump (66).

11. A machine for dispensing dyes, inks, paints or similar fluid products, comprising at least one reservoir (102) of products to be dispensed, characterized in that it comprises at least one dispensing circuit (10) according to any one of the preceding claims, and in that said pump means connected to the at least one reservoir (102).

12. A dispensing machine according to claim 11, characterized in that it comprises a control system (106) for controlling the pump means (12) so as to deliver a predetermined quantity of fluid.
